(19) United States
(12) Patent Application Publication
(10) Pub. No.: US 2011/0164570 A1
(43) Pub. Date: Jul. 7, 2011

(54) GATEWAY APPARATUS, METHOD, SYSTEM, AND PROGRAM

(76) Inventor: Kazunori Ozawa, Tokyo (JP)

(21) Appl. No.: 13/060,993

(22) PCT Filed: Sep. 25, 2009
(86) PCT No.: PCT/JP2009/066667

§ 371 Date: Feb. 25, 2011

(30) Foreign Application Priority Data
Sep. 26, 2008 (JP) 2008-248152

(51) Int. Cl. H04L 12/56; H04L 12/66; H04W 4/00

(52) U.S. Cl. 370/328; 370/401

(57) ABSTRACT

A gateway apparatus receives an image signal, including a moving image or a still image and transmitted from the first terminal to a first network, performs a conversion of the received image signal for enhancing resolution and image quality thereof, transmits the converted image signal to the second terminal connected to the second network, receives an image signal, including a moving image or a still image, and transmitted from a second terminal to the second network 170, and outputs the received image signal to the first network. The first terminal receives the image signal, output from the gateway apparatus to the first network, decodes the received image signal, and performs a conversion for enhancing resolution and image quality thereof, and displays the image signal.

### CROSS-REFERENCE TO RELATED APPLICATIONS

The present application is the National Phase of PCT/JP2009/066667, filed Sep. 25, 2009, which claims priority from Japanese Patent Application 2008-248152 (filed on Sep. 26, 2008) the content of which is hereby incorporated in its entirety by reference into this specification.

### TECHNICAL FIELD

The present invention relates to a gateway apparatus, a method, and a system.

### BACKGROUND

There have been started services for connecting different networks including a first network which is a mobile network, for example, and a second network which is a packet network or a next generation network (NGN), for example, and for exchanging a moving image or a still image between the terminals connected to the respective networks. In these services, a gateway apparatus is used.

When communications using a moving image or a still image are carried out between terminals, the terminal performs compression encoding of the moving image in order to transmit the moving image efficiently at a low bit rate. As these compression encoding schemes, ITU-T(International Telecommunication Union for Telecommunication Standardization sector) Recommendation H.263 and MPEG-4(Moving Picture Experts Group Phase 4) internationally standardized by ISO/IEC(International Organization for Standardization/International Electro technical Commission) are known. In addition, H.264/MPEG-4 AVC(Advanced Video Coding), internationally standardized by ITU-T and ISO/IEC, compresses data more efficiently than the moving image compression encoding schemes described above.

As a gateway that converts a moving image, Patent Document 1 discloses a gateway that converts moving image data, which is received from a server, using encoded parameters (encoding scheme, frame size, etc.) derived from characteristics of a terminal to which the moving image data is to be transmitted. As a configuration for increasing the temporal resolution, Patent Document 2 discloses a configuration in which the number of samples (frame rate) in the time-axis direction of a low-resolution moving image is increased (up-sampled), unwanted high-frequency components are eliminated, and a high-frequency prediction is made along a time-axis direction through non-linear prediction and, if the high-frequency prediction is correct, a temporal resolution is extended. As will be apparent from the description below, the present invention is absolutely different from the inventions described in those Patent Documents.
Patent Document 1:
Japanese Patent Kokai Publication No. JP2001-313937A
Patent Document 2:
Japanese Patent Kokai Publication No. JP2007-74307A

### SUMMARY

The following gives an analysis by the present invention.

In the service and the apparatus of the related art, there are often cases in which a bandwidth of the second network, especially its downlink bandwidth, is several times wider than the bandwidth of the first network, especially its uplink bandwidth, and so a second terminal connected to the second network has the ability to process a higher-definition image. Even in such a case, the gateway apparatus transmits a moving image signal or a still image signal, which is transmitted from a first terminal connected to the first network and which has an insufficient resolution and an insufficient image quality, directly to the second network. As a result, the moving image or the still image has an insufficient resolution and an insufficient image quality when displayed on the second terminal connected to the second network. This problem makes it difficult to increase the number of subscribers of the service itself.

In transmission from the second terminal to the first terminal, the first terminal receives a signal whose resolution or image quality is lowered according to a capability of the first terminal or according to a bandwidth of the first network. As a result, the resolution and the image quality of a moving image signal or still image signal which is received and decoded by the first terminal are insufficient for a user of the first terminal.

It is an object of the present invention to provide a communication system, a method, and a gateway apparatus for allowing a sufficient resolution and image quality to be given to an image signal including a moving image signal or a still image signal, received from a first terminal connected to a first network, when the image signal is transmitted to a second terminal connected to a second network, and for allowing a resolution and an image quality, sufficient for the first terminal, to be given to an image signal including a moving image signal and a still image signal, that is transmitted from the second terminal, received by a gateway apparatus, and transmitted to the first terminal.

The invention disclosed by this application provides the following general configuration, though not limited thereto.

In one aspect of the present invention, there is provided a communication system comprising: A communication system comprising: a first network; a first terminal connected to the first network; a second network; a second terminal connected to the second network; and a gateway apparatus connected to the first and second networks, wherein the gateway apparatus comprises a conversion unit that performs conversion of an image signal for enhancing resolution and image quality thereof. The gateway apparatus receives an image signal that includes a moving image or a still image, and that is transmitted from the first terminal to the first network, performs conversion of the received image signal for enhancing resolution and image quality thereof, using the conversion unit, and transmits a image signal resulting from the conversion to the second terminal connected to the second network. The gateway apparatus further receives an image signal that includes a moving image or a still image, and that is transmitted from the second terminal to the second network, and outputs the received image signal to the first network. The first terminal comprises a conversion unit that performs conversion of an image signal for enhancing resolution and image quality thereof, wherein the first terminal receives the image signal output from the gateway apparatus to the first network, decodes the received image signal, and performs conversion of the decoded image signal for enhancing resolution and image quality thereof, using the conversion unit of the first terminal.

In another aspect of the present invention, there is provided a communication method comprising:

a gateway receiving an image signal that includes a moving image or a still image, and that is transmitted from a first terminal via a first network;

the gateway performing conversion of the received image signal for enhancing resolution and image quality to transmit an image signal resulting from the conversion to a second terminal via a second network,

the gateway receiving an image signal that includes a moving image or a still image, and that is transmitted from the second terminal via the second network and outputting the received image signal to the first network; and

the first terminal receiving an image signal output from the gateway to the first network, decoding the received image signal, and converting the decoded image signal for enhancing resolution and image quality thereof.

In still another aspect of the present invention, there is provided a gateway apparatus that is connected to a first terminal connected to a first network and that is connected to a second terminal connected to a second network, the gateway apparatus comprising:

a first reception unit that receives an image signal including a moving image or a still image, the image signal transmitted from the first terminal via the first network;

a conversion unit that performs conversion of the received image signal for enhancing resolution and image quality thereof;

a first transmission unit that transmits an image signal resulting from the conversion to the second terminal connected to the second network;

a second reception unit that receives an image signal including a moving image or a still image, the image signal transmitted from the second terminal via the second network, the image signal; and

a second transmission unit that transmits the received image signal to the first terminal connected to the first network.

In still another aspect of the present invention, there is provided a program that causes a computer, which configures a gateway apparatus that is connected to a first terminal connected to a first network and that is connected to a second terminal connected to a second network, to perform:

processing of receiving an image signal that includes a moving image or a still image, and that is transmitted from the first terminal via the first network;

conversion processing of performing conversion of the received image signal for enhancing resolution and image quality thereof;

processing of transmitting an image signal resulting from the conversion to the second terminal connected to the second network;

processing of receiving an image signal that includes a moving image or a still image, and that is transmitted from the second terminal via the second network; and

processing of transmitting the received image signal to the first terminal connected to the first network.

In still another aspect of the present invention, there is provided a terminal that transmits an image signal to a gateway apparatus via a first network and that receives an image signal transmitted to the gateway apparatus via a second network, the image signal including a moving image or a still image,

the terminal comprising:

a reception unit that receives an image signal including a moving image or a still image, via the gateway apparatus, from a second terminal connected to the second network;

a decoding unit that decodes the received image signal;

a conversion unit that converts resolution of the decoded image signal for improving image quality thereof; and

a display unit that displays the converted signal.

In still another aspect of the present invention, there is provided a program that causes a computer, which configures a terminal that transmits an image signal to a gateway apparatus via a first network and that receives an image signal transmitted to the gateway apparatus via a second network, to perform processing, the image signal including a moving image and a still image, the processing including:

reception processing that receives an image signal that includes a moving image or a still image from a second terminal, connected to the second network, via the gateway apparatus;

decoding processing that decodes the received image signal;

conversion processing that converts resolution of the decoded image signal for improving image quality thereof; and

display processing that displays the converted signal.

The present invention allows a sufficient resolution and a sufficient image quality to be given to the image signal of a moving image or a still image, received from a first terminal connected to a first network, when the image signal is transmitted to a second terminal connected to a second network and, in addition, allows a resolution and an image quality, sufficient for the first terminal, to be given to the image signal, including a moving image or a still image, that is transmitted from the second terminal, received by a gateway apparatus, and then transmitted to the first terminal. Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing the system configuration of one exemplary embodiment of the present invention.

FIG. 2 is a diagram showing the configuration of a gateway apparatus in a first exemplary embodiment of the present invention.

FIG. 3 is a diagram showing the configuration of the gateway apparatus in the first exemplary embodiment of the present invention.

FIG. 4 is a diagram showing the configuration of a first terminal in the first exemplary embodiment of the present invention.

FIG. 5 is a diagram showing the configuration of a gateway apparatus in a second exemplary embodiment of the present invention.

FIG. 6 is a diagram showing the configuration of the gateway apparatus in the second exemplary embodiment of the present invention.

FIG. 7 is a diagram showing the configuration of a first terminal in the second exemplary embodiment of the present invention.

FIG. 8 is a diagram showing the processing procedure of the gateway apparatus in the first exemplary embodiment of the present invention.

FIGS. 9A and 9B are diagrams showing modifications the gateway apparatus and the first terminal in the exemplary embodiments of the present invention.

### PREFERRED MODES

The following describes modes for carrying out the present invention. According to one of modes of the present invention, a communication system comprises a first network, a first terminal connected to the first network, a second network, a second terminal connected to the second network, and a gateway apparatus connected to the first and second networks, wherein the gateway apparatus receives an image signal including a moving image or a still image, which is transmitted from the first terminal to the first network, and comprises:

a conversion unit that performs conversion of the received image signal for enhancing resolution and image quality thereof;

a transmission unit that transmits an image signal resulting from the conversion to the second terminal connected to the second network;

a reception unit that receives an image signal, including a moving image or a still image, which is transmitted from the second terminal to the second network; and

a second transmission unit that outputs the received image signal to the first network. The first terminal comprises a conversion unit that receives the image signal output from the gateway apparatus to the first network, decodes the received image signal, and converts the decoded image signal for enhancing resolution and image quality thereof.

According to the present invention, a communication system is provided in which a first terminal, a first network, a gateway apparatus, a second network, and a second terminal are connected. The gateway apparatus comprises a conversion unit that receives a stream or a packet, including a moving image or a still image signal, from the first terminal and converts the received stream or packet for enhancing resolution and image quality thereof; a transmission unit that transmits a signal resulting from the conversion to the second terminal connected to the second network, and a transmission unit that receives a packet or a stream, including a moving image or a still image, from the second terminal via the second network and outputs the received packet or the stream to the first network. The first terminal comprises a conversion unit that receives the output, decodes the received output, and converts the decoded output for enhancing resolution and image quality thereof.

According to the present invention, a communication system is provided in which a second terminal is connected to a second network, a packet or a stream, including a moving image or a still image, is transmitted from the second terminal to the second network, a gateway apparatus comprises a reception unit that receives the packet or the stream and a transmission unit that outputs the packet or the stream to a first network, and a first terminal, connected to the first network, comprises a conversion unit that receives the output from the transmission unit, decodes the received output, and converts the decoded output for enhancing resolution and image quality thereof.

According to the present invention, a communication system is provided in which a first network is a mobile circuit-switched network or a mobile packet network and a second network is a packet network or an NGN network.

According to the present invention, a communication system is provided in which a first network is a mobile circuit-switched network or a mobile packet network and a second network is a 3.9th generation or 4th generation mobile packet network. The following describes the present invention with reference to exemplary embodiments. In the exemplary embodiments, an example of the configuration in which a video (moving image) signal is used.

### Exemplary Embodiments

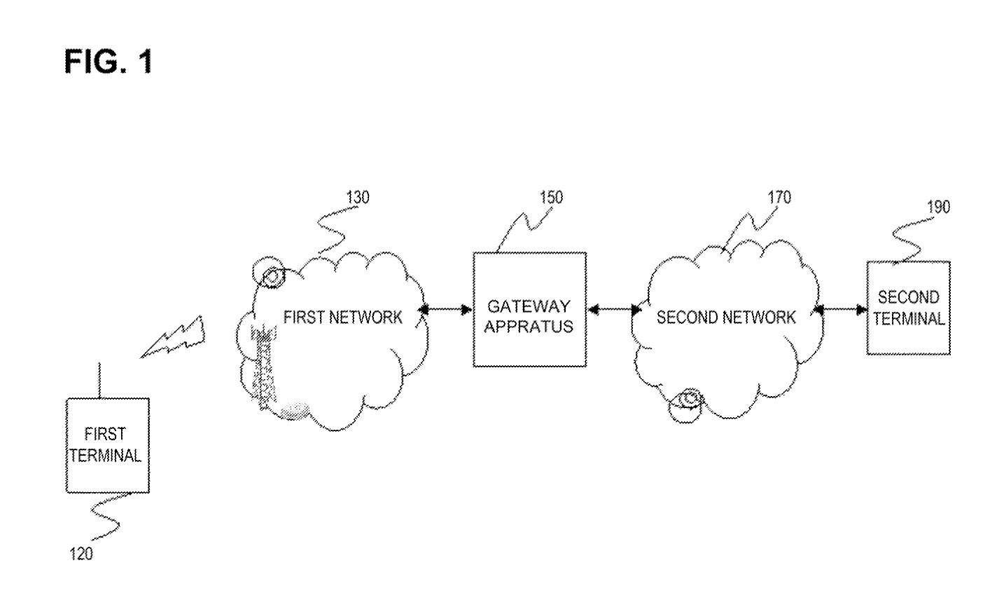

FIG. 1 is a diagram showing the configuration of a communication system according to the present invention. FIG. 1 shows an example of the connection mode in which a gateway apparatus, a first network, a second network, a first terminal, and a second terminal are connected.

In FIG. 1, the reference numeral 120 designates a first terminal, for example, a mobile terminal. The reference numeral 130 designates an example of a first network, for example, a mobile network. A gateway apparatus 150 converts a video stream or a video packet, received from the first terminal 120 via the first network 130, to enhance the resolution and the image quality and, after that, transmits the converted moving image stream or packet to a second terminal 190 via a second network 170. The second network 170 is, for example, a non-mobile, packet network or a next generation network (NGN). On the other hand, the gateway apparatus 150 receives a moving image signal or a still image signal transmitted from the second terminal 190 and transmits the moving image signal or the still image signal received to the first terminal 120. The first terminal 120 decodes and displays the signal from the second terminal 190.

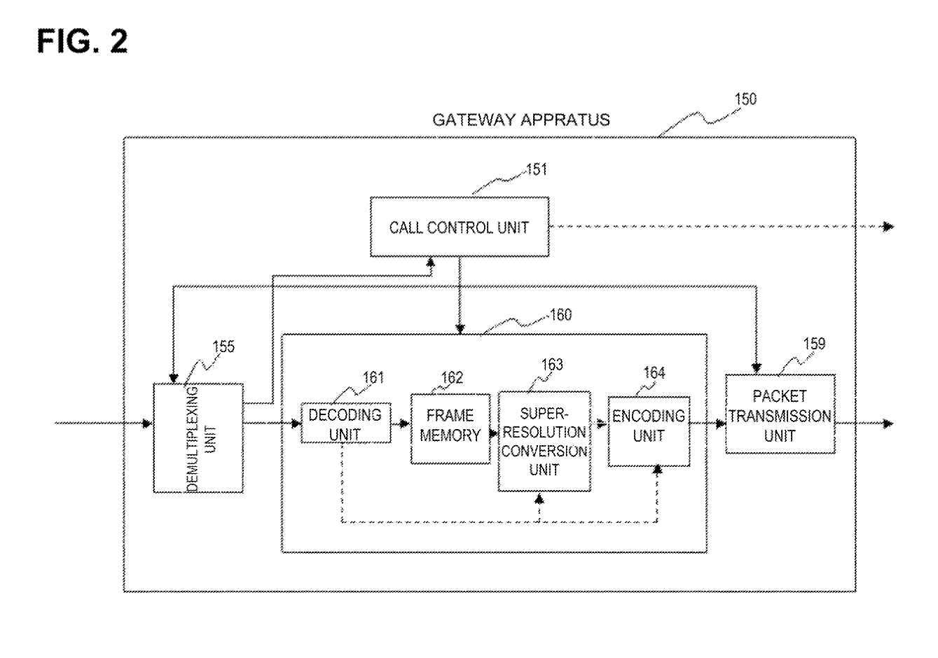

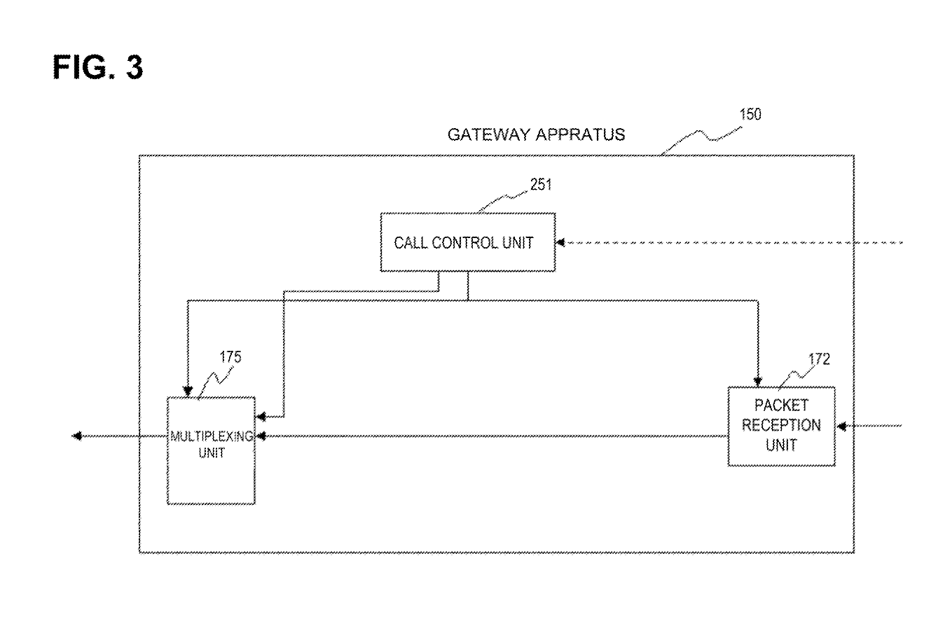

The present invention is applicable to two types of the mobile network 130, a mobile circuit-switched network and a mobile packet network, and the configuration of the gateway apparatus 150 depends on which type of the mobile network 130 is used. Therefore, the following shows the configuration of the gateway apparatus 150 for each network type in FIG. 2 and FIG. 3.

This exemplary embodiment is applicable to two types of the mobile network 130, a mobile circuit-switched network and a mobile packet network, and the configuration of the gateway apparatus 150 depends on which type of the mobile network 130 is used. The following shows the configuration of the gateway apparatus 150 for each network type in FIG. 2 and FIG. 3.

FIG. 2 is a diagram showing an example of the main part configuration of the gateway apparatus 150 when the mobile network 130 is a mobile circuit-switched network. The gateway apparatus 150 comprises a demultiplexing unit 155, a call control unit 151, a conversion unit 160, and a packet transmission unit 159.

The first mobile terminal 120 in FIG. 1 is assumed to have the 3G-324M protocol (call connection control protocol for a 3G mobile phone network and an IP network) installed. For the detail description of the 3G-324M protocol, see the 3GPP TS26.110 specification or TR26.911 specification.

FIG. 3 is a diagram showing an example of the gateway apparatus 150 on a reverse path from the second terminal to the first terminal.

In FIG. 2, the demultiplexing unit 155 receives the H.223 multiplexed signal, demultiplexes the signal into the H.245 call control signal, video signal, and audio signal, outputs the demultiplexed H.245 call control signal to the call control unit 151, and outputs the demultiplexed video signal to a decoding unit 161 of the conversion unit 160. For the details of H.223 and H.245, see the ITU-T H.223 specification and ITU-T H.245 specification.

The call control unit 151 analyzes the H.245 call control signal and outputs capability information on the first terminal, which is required for decoding the video signal, to the decoding unit 161 of the conversion unit 160. For example, the capability information includes as follows:

Video codec: MPEG-4 SP (Simple Profile) Level 0;

Bit rate: 64 kbps (kilobits/second);

Image resolution: QCIF(Quadrature Common Intermediate Format); and

Frame rate: 15 fps (frames/second).

In addition, the call control unit 151 exchanges the call control information (for example, reception IP address of the second terminal 190) and capability information with the second terminal 190 via the second network 170, using SIP(Session Initiation Protocol) and SDP(Session Description Protocol) (this information exchange is indicated by the broken line from the call control unit 151). The call control unit 151 transmits this capability information to the conversion unit 160. The capability information on the second terminal is, for example, such that H.264 BP(Baseline Profile) is provided as a video codec in the second terminal with the BP profile level thereof being able to accommodate up to level 1.2. This means that the maximum bit rate is 384 kbps, the screen resolution corresponds to CIF(Common Intermediate Format), and the frame rate is 15 fps.

The conversion unit 160 comprises the decoding unit 161, a frame memory 162, a super-resolution conversion unit 163, and an encoding unit 164.

The decoding unit 161 receives the capability information on the first terminal from the call control unit 151 and decodes the video signal by MPEG-4 SP level 0, with the bit rate of 64 kbps, screen resolution corresponding to QCIF, and frame rate of 15 fps. The decoded video signal is once stored in the frame memory 162 on a per frame basis.

The super-resolution conversion unit 163 receives the capability information on the second terminal from the call control unit 151, reads the video signal stored in the frame memory 162, and improves the image quality by enhancing the resolution.

To enhance the resolution, one of the following methods is used.
The resolution is enhanced by increasing the number of pixels using a plurality of image frames, as a reference image for the image frame to be converted and
The number of pixels is increased using pixels in different positions in the image frame to be converted.

The super-resolution conversion unit 163 may be configured to select an optimal method from those methods under the constraint of a computation amount and a memory amount that can be allotted to processing of the super-resolution conversion unit 163.

When a past (previous in time) reference frame is used for the frame to be converted, the super-resolution conversion unit 163 receives a motion vector of each of macro-blocks decoded by the decoding unit 161 and re-executes a motion vector search processing (determines a position of a macro-block, among macro blocks in a search range of the reference frame, which has the smallest difference from the macro-block of the frame to be converted is the smallest) for pixels included in the macro-block based on the motion vector to find a detailed motion vector (for example, on a half-pixel basis). The super-resolution conversion unit 163 may employ a configuration in which the number of pixels of the frame to be converted is increased by applying the detailed motion vector, found by the re-search, to pixels of the past reference frame and by using the frame that is moved according to the detailed motion vector. The super-resolution conversion unit 163 may also employ a configuration in which, instead of using the motion vectors of the macro-blocks received from the decoding unit 161, a motion vector is searched for from the frame to be converted (current frame) and a reference frame.

When only frames whose resolution are to be enhanced are used, the super-resolution conversion unit 163 enhances the resolution and improves the image quality by performing the processing in which an edge part is detected and the number of pixels is increased using pixels near the edge, or pixels near the edge are corrected, or in which the edge part is detected and emphasis thereof is performed. This processing is performed for a moving image and/or a still image.

By estimating the motion direction, the super-resolution conversion unit 163 interpolates a frame image in the temporal direction (inserts one frame between the preceding and following frames) and interpolates a frame rate to extend the frame rate, for example, from 15 fps to 30 fps.

The encoding unit 164 receives the capability information on the second terminal from the call control unit 151, receives the output signal from the super-resolution conversion unit 163, and encodes the signal using, for example, the H.264 BP Level 1.2 encoding scheme with the bit rate of 384 kbps, the screen resolution corresponding to CIF, and the frame rate of 15 fps.

To reduce a computation amount of the motion vector search, the encoding unit 164 may also be configured to receive motion vector information from the decoding unit 161 and, based on the received motion vector information (conversion corresponding to extension in the resolution is performed for the motion vector), to search for a new motion vector in a neighborhood of the received motion vector in the image signal converted by the super-resolution conversion unit 163.

The packet transmission unit 159 receives the reception IP address of the second terminal 190 from the call control unit 151, receives an H.264 compressed encoded stream from the encoding unit 164, and transmits the compressed encoded stream, including the RTP payload, to the reception IP address as an RTP packet.

The RTP packet, transmitted by the packet transmission unit 159, is received by the second terminal 190 via the second network 170.

Next, with reference to FIG. 3, the following describes an exemplary embodiment of the gateway apparatus 150 that transmits signals from the second terminal to the first terminal. In FIG. 3, the same reference numerals are used for the corresponding elements of FIG. 2. Because an element in FIG. 3 corresponding to an element with the same element in FIG. 2 performs the same operation, the description of the same element will be omitted below.

In FIG. 3, a packet reception unit 172 receives a video RTP packet from the second terminal 190 via the second network 170, reads a video stream stored in a RTP payload, and outputs the video stream to a multiplexing unit 175.

The multiplexing unit 175 multiplexes an H.245 call control signal, received from a call control unit 251, and a video stream based on the H.223 protocol and transmits a multiplexed stream to the first network 130.

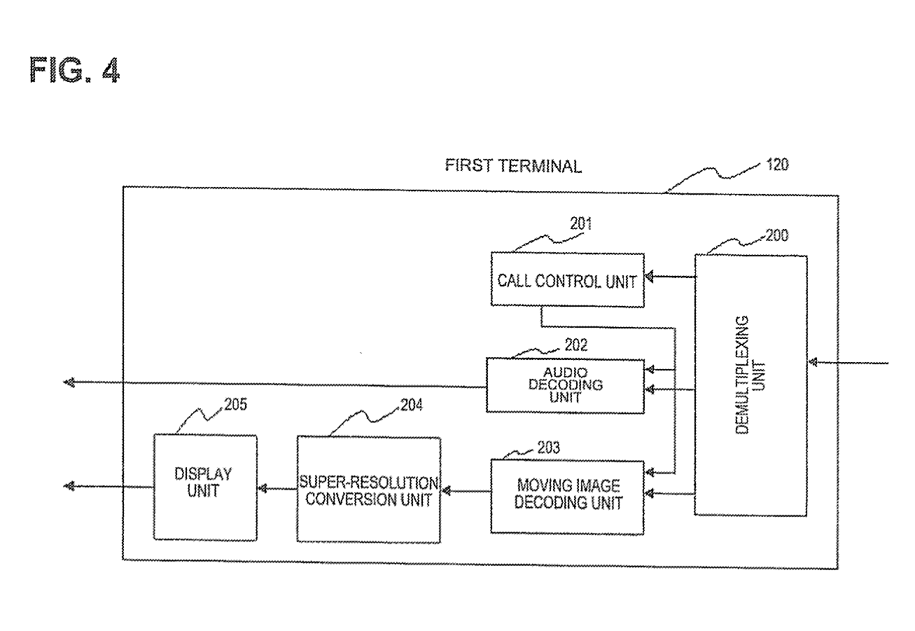

FIG. 4 is a diagram showing an example of the configuration of principal portions of the first terminal 120 used for the communication from the second terminal to the first terminal. Referring to FIG. 4, the first terminal 120 comprises a demultiplexing unit 200, a call control unit 201, an audio decoding unit 202, a moving image decoding unit 203, a super-resolution conversion unit 204, and a display unit 205.

In FIG. 4, the demultiplexing unit 200 receives an H.223 multiplexed signal, demultiplexes the received signal into an H.245 call control signal, a compressed encoded video stream, and a compressed encoded audio stream, and outputs a demultiplexed H.245 call control signal to the call control unit 201, a demultiplexed compressed encoded video stream to the moving image decoding unit 203, and a demultiplexed compressed encoded audio stream to the audio decoding unit 202.

The call control unit 201 performs call control using the H.245 call control signal, extracts capability information, generated when the moving image signal and the audio signal have been encoded by the second terminal, from the H.245 call control signal, and outputs capability information extracted to the moving image decoding unit 203 and the audio decoding unit 202.

The audio decoding unit 202 receives the capability information from the call control unit 201, receives the compressed encoded audio stream from the demultiplexing unit 200, and decodes and outputs the audio using a predetermined audio codec. In this exemplary embodiment, the audio codec is AMR(Adaptive Multi-Rate). For the detail of AMR, refer to the 3GPP TS26.071 specification and the TS26.090 specification.

The moving image decoding unit 203 receives the capability information from the call control unit 201, receives the compressed encoded video stream from the demultiplexing unit 200, receives the compressed encoded video stream, decodes the stream using a moving image codec (for example, MPEG-4 SP@L0) and the screen resolution (for example, QCIF) specified by the capability information, and outputs the decode video signal to the super-resolution conversion unit 204.

The super-resolution conversion unit 204 receives the decoded video signal and improves the image quality by enhancing the resolution. For example, the super-resolution conversion unit 204 enhances the resolution from the resolution corresponding to QCIF to the resolution corresponding to CIF. To do so, there are two methods as described above: one method is that the resolution is enhanced by increasing the number of pixels using a plurality of image frames as a reference image for the image frame to be converted and the other method is that the number of pixels is increased using pixels in different positions in the image frame to be converted. The super-resolution conversion unit 204 may be configured to select an optimal method from those methods under the constraint of an operation amount and a memory amount that can be alloted to the processing.

As with the gateway apparatus 150 described above, when a past reference frame is used for the frame to be converted, the super-resolution conversion unit 204 may be configured to receive the motion vector of each of the macro-blocks from the moving image decoding unit 203, to perform again searching in a predetermined range for pixels included in the macro-block, based on a received motion vector to find for a detailed motion vector, and to increase the number of pixels of the frame to be converted by applying the detailed motion vector to pixels of the past reference image frame and by moving pixels according to the motion vector.

In addition, the frame rate may be increased by estimating a motion direction and interpolating a frame image along a temporal direction. For example, the frame rate may be extended from 15 fps to 30 fps.

Of course, a configuration that does not use a motion vector is possible. In addition, when only a frame whose resolution is to be enhanced is used, the resolution may be increased and the image quality may be improved by detecting an edge portion and by applying pixels near the edge to the increase of the number of pixels or by applying correction to pixels near the edge.

The super-resolution conversion unit 204 outputs the moving image signal that has undergone the super-resolution conversion to the display unit 205. The display unit 205 receives the converted moving image signal and displays it.

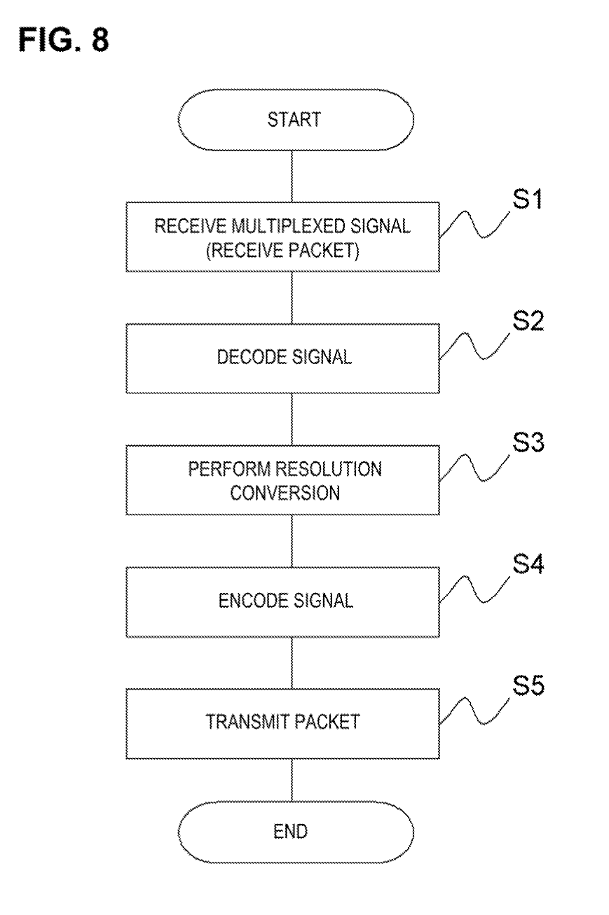

The following describes the processing steps of the gateway apparatus in this exemplary embodiment with reference to FIG. 8.

Step S1: The demultiplexing unit 155 receives a multiplexed signal from the first terminal, demultiplexes the received signal into an H.245 call control signal and a video signal, outputs the H.245 all control signal de-multiplexed to the call control unit 151, and supplies the video signal de-multiplexed to the decoding unit 161 of the conversion unit 160.

Step S2: The decoding unit 161 decodes the video signal according to the capability information on the first terminal received from the call control unit 151.

Step S3: The super-resolution conversion unit 163 improves the image quality by enhancing the resolution of the decoded video signal.

Step S4: The encoding unit 164 encodes the video signal received from the super-resolution conversion unit 163 based on the capability information on the second terminal received from the call control unit 151.

Step S5: The packet transmission unit 159 receives the encoded signal from the encoding unit 164 and transmits an RTP packet with the encoded signal in the RTP payload.

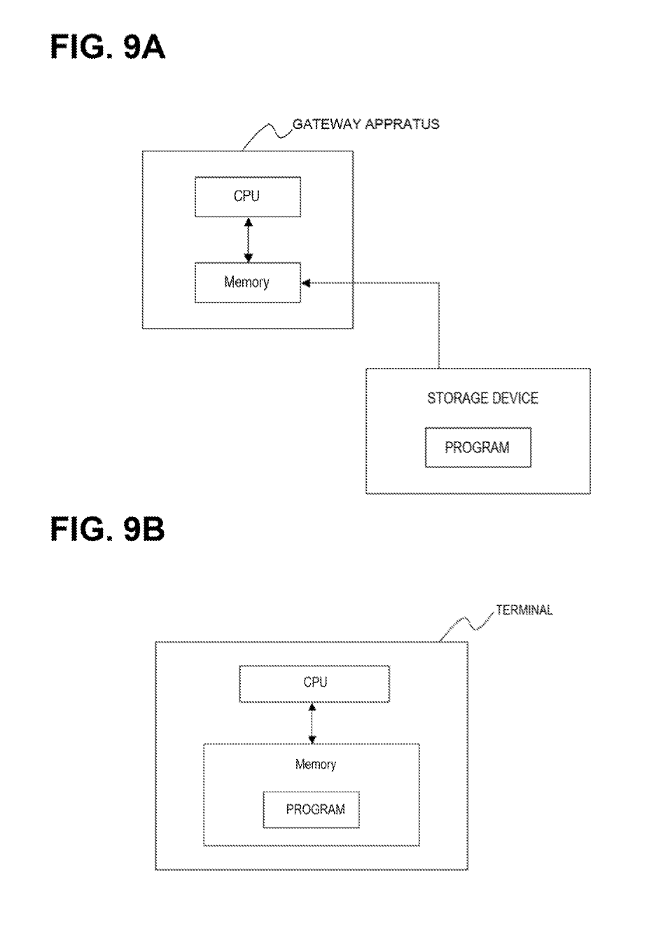

The function and the processing of steps S1 to S5 of the gateway apparatus described above may, as a matter of course, be implemented by programs executed on a computer configuring the gateway apparatus. This is also true in the exemplary embodiment that will be described later. As shown in FIG. 9A, the computer (CPU) that configures the gateway apparatus implements the processing of the conversion unit described above and the processing of the demultiplexing unit, packet transmission unit, and call control unit, by loading the programs from a storage apparatus into a memory for execution therein. The storage apparatus, in which the programs are stored, may of course be connected to the gateway apparatus over the network.

Next, the following describes the processing steps of the first terminal in this exemplary embodiment for receiving a signal from the second terminal via the second network, gateway apparatus, and first network.

Step 1: The demultiplexing unit 200 demultiplexes a received signal from the second terminal into the H.245 call control signal and the video signal, outputs a demultiplexed H.245 call control signal to the call control unit 201, and outputs a demultiplexed video signal to the moving image decoding unit 203.

Step 2: The moving image decoding unit 203 decodes the video signal received from the demultiplexing unit 200.

Step 3: The super-resolution conversion unit 204 improves the image quality by enhancing the resolution of the decoded video signal. Steps 1-3 described above correspond to steps S1-S3 in FIG. 8.

Step 4: The display unit 205 receives the converted moving image signal and displays it.

The function and the processing of steps 1 to 4 of the first terminal described above may of course be implemented by programs executed on the computer configuring the first terminal. This is also true in the exemplary embodiment that will be described later. As shown in FIG. 9B, the computer (CPU) that configures the first terminal implements the processing of the super-resolution conversion unit and the processing of the demultiplexing unit, call control unit, and moving image decoding unit by executing the programs stored in the memory. The storage apparatus, in which the programs are stored, may of course be connected to the first terminal over the network.

In the exemplary embodiment described above, any video compression encoding scheme may be used, for example, any of H.263, MPEG-4, and H.264 may be used

The following describes the effect of the first exemplary embodiment of the present invention.

According to the first exemplary embodiment, in the communication from the first terminal to the second terminal, the gateway performs the conversion, in which the resolution and the image-quality are enhanced, for the moving image signal and the still image signal, received from the first terminal (for example, a mobile terminal) connected to the first network (for example, mobile network), and then transmits the converted moving image signal or still image signal to the second terminal connected to a packet network. This capability provides the service that utilizes the wide bandwidth of the downlink of the second network (for example, a packet network or an NGN) and the high performance of the second terminal, thus allowing the second terminal to enjoy high image-quality images.

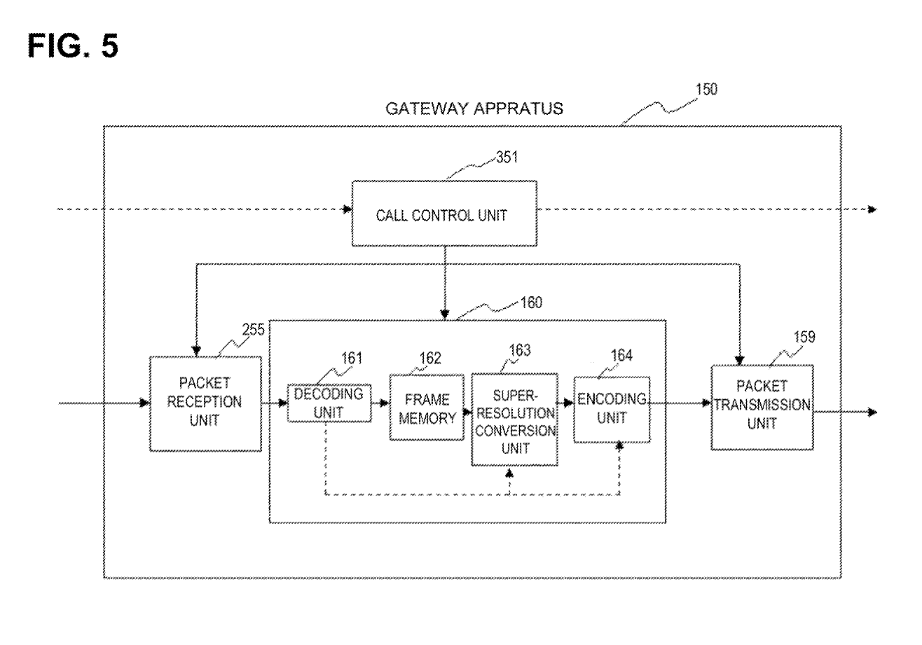

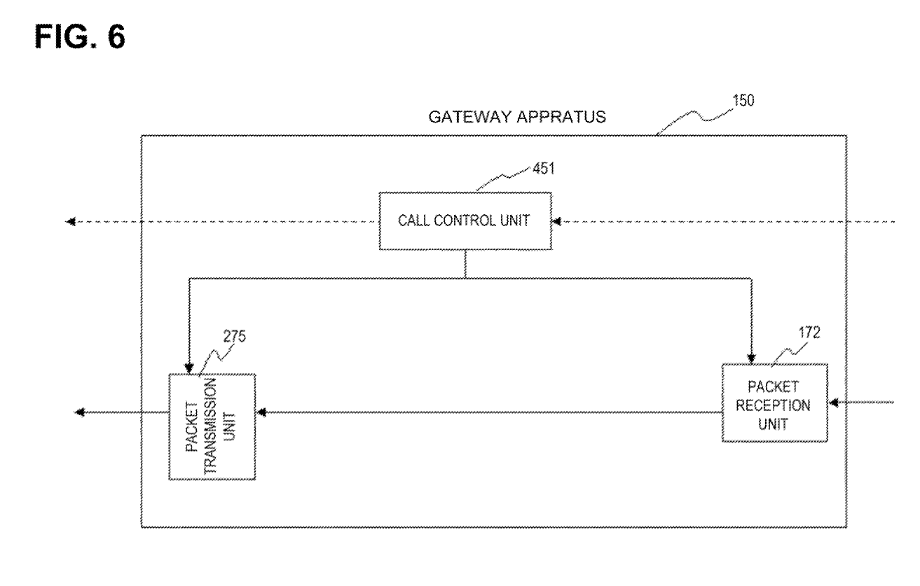

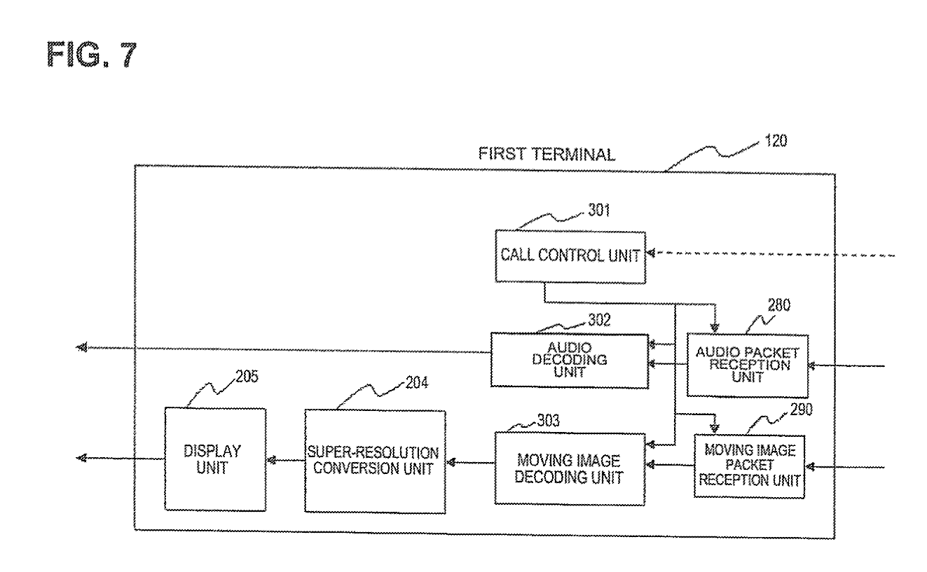

Next, a second exemplary embodiment of the present invention will be described. FIG. 5 and FIG. 6 show the configuration of a gateway apparatus 150 when a mobile network 130 is a mobile packet network. FIG. 5 shows the configuration of the gateway apparatus when the communication is carried out from a first terminal to a second terminal, and FIG. 6 shows the configuration of the gateway apparatus when the communication is carried out from the second terminal to the first terminal. FIG. 7 shows the configuration of the first terminal when the communication is carried out from the second terminal to the firsts terminal. In FIG. 5, the same reference numerals are used for the corresponding elements of FIG. 2. Because an element in FIG. 5 corresponding to an element with the same element in FIG. 2 performs the same operation, the description of the same element will be omitted below.

In FIG. 5, a call control unit 351 receives a session control signal, which is a SIP signal, from a first terminal 120. In addition, the call control unit 351 receives the capability information on the first terminal 120 described using SDP(Session Description Protocol) (indicated by the broken line in FIG. 5). The call control unit 351 outputs the capability information on the first terminal 120 to a conversion unit 160. The capability information on the first terminal 120 is that the video codec is MPEG-4 SP(Simple Profile) Level 0, the bit rate is 64 kbps(kilobits/second). The screen resolution corresponds to QCIF, and the frame rate is 15 fps(frames/second).

In addition, the call control unit 351 exchanges, call control information (for example, the reception IP address of a second terminal 190) and the capability information with the second terminal 190 using SIP(Session Initiation Protocol) and SDP(Session Description Protocol) (signal indicated by the broken line in FIG. 5). In the description below, the capability information is that the H.264 BP(Baseline Profile) is installed as the video codec and that the BP profile up to level 1.2 may be used. This means that the maximum bit rate is 384 kbps, the screen resolution corresponds to CIF, and the frame rate is 15 fps. The call control unit 351 transmits this information to the conversion unit 160.

A packet reception unit 255 receives the capability information on the first terminal 120 from the call control unit 351. The packet reception unit 255 receives a video packet from the first terminal 120 via the mobile packet network 130, reads the video stream stored in the payload part of the packet, and outputs the video stream to a decoding unit 161 of the conversion unit 160.

The conversion unit 160 receives the capability information on the first terminal 120 and the capability information on the second terminal 190 from the call control unit 351, supplies the former to the decoding unit 161, and supplies the latter to a super-resolution conversion unit 163 and an encoding unit 164. Because the operation of the conversion unit 160 is the same as that of the conversion unit 160 in FIG. 2, its description is omitted.

A packet transmission unit 159 receives the IP address of the second terminal, which is a transmission destination from, the call control unit 351 and, in addition, receives the converted video stream from the conversion unit 160. Because the operation of the packet transmission unit 159 is the same as that of the packet transmission unit 159 in FIG. 2, its description is omitted. The super-solution conversion processing steps in the gateway apparatus in this exemplary embodiment are the same as those in the flowchart in FIG. 8 referenced in the first exemplary embodiment except that the packet reception processing is performed in step S1 and, therefore, the description is omitted.

FIG. 6 is a diagram showing the configuration of the gateway apparatus used in the communication from the second terminal to the first terminal. Because an element in FIG. 6 corresponding to an element with the same numeral in FIG. 3 performs the same operation of the element in FIG. 3, the description will be omitted below.

In FIG. 6, a call control unit 451 receives a session control signal, which is a SIP signal, from the second terminal 190 and receives the capability information described using SDP(Session Description Protocol) (indicated by the broken line, an input to the call control unit 451 in FIG. 6). The call control unit 451 outputs the information to a packet reception unit 172 and a packet transmission unit 275 and, at the same time, transmits the information to the first terminal 120 (broken line output from the call control unit 451 in FIG. 6).

The packet transmission unit 275 receives a reception IP address of the first terminal 120 and from the call control unit 451, receives the video RTP packet from the packet reception unit 172, and transmits the video RTP packet to the first network 130.

FIG. 7 is a diagram showing the configuration of the first terminal 120 that is connected to a mobile packet network for use in the communication from the second terminal 190 to the first terminal 120. Because each element in FIG. 7 corresponding to an element with the same numeral in FIG. 4 performs the same operation of the element in FIG. 4, the description will be omitted below.

In FIG. 7, a call control unit 301 receives a session control signal by a SIP signal, from the gateway apparatus 150. In addition, the call control unit 301 receives the capability information on the video signal described using SDP(Session Description Protocol) (indicated by the broken line input to the call control unit 301 in FIG. 7). The call control unit 301 outputs the information to a moving image decoding unit 303, an audio decoding unit 302, a moving image packet reception unit 290, and an audio packet reception unit 280. The capability information is that the video codec is MPEG-4 SP(Simple Profile) Level 0, the bit rate is 64 kbps, the screen resolution corresponds to QCIF, the frame rate is 15 fps, and the audio codec is AMR(Adaptive Multi-Rate).

The moving image packet reception unit 290 receives the capability information on the video signal from the call control unit 301, receives a video RTP packet from the mobile network 130, reads the video stream stored in the payload part of the RTP packet, and outputs the video stream to the moving image decoding unit 303.

The moving image decoding unit 303 receives capability information on the video signal from the call control unit 301, receives a video stream from the moving image packet reception unit 290, and decodes and output the video signal according to the capability information. In this exemplary embodiment, it is assumed that a compression encoding scheme adopted is MPEG-4 sp@L0, a screen resolution corresponds to QCIF, bit rate is 64 kbps, and frame rate is 15 fps.

The audio packet reception unit 280 receives an audio RTP packet from the mobile network 130 and reads and outputs the audio stream stored in the payload part of the .RTP packet.

The audio decoding unit 302 receives the audio codec information from the call control unit 301 as the capability information, receives an audio stream from the audio packet reception unit 280, and decodes and outputs the audio. The audio codec is, for example, the AMR audio codec.

The following describes the effect of the second exemplary embodiment of the present invention.

According to the second exemplary embodiment, in the communication from the second terminal to the first terminal, the first terminal decodes the moving image signal or the still image signal received from the gateway, converts the decoded signal for enhancing resolution and image quality thereof, and outputs and displays the images, thus allowing the first terminal to enjoy high image-quality images.

Although the call control unit that performs C-Plane (Control Plane) processing and the H.223 demultiplexing unit, packet reception unit, conversion unit, and a packet transmission unit that perform the U-Plane (User Plane) processing are all arranged in the server apparatus in the exemplary embodiments described above, a configuration is also possible in which the C-Plane processing and the U-Plane processing are performed in separate apparatuses. Such a configuration ensures scalability independently for the C-Plane and the U-Plane.

Although the video (moving image) signal is processed in the exemplary embodiments described above, the same configuration is also possible for the still image signal.

The whole or part of the exemplary embodiments disclosed above can be described as, but not limited to, the following supplementary notes.

(Supplementary note 1) A communication system comprising a first network, a first terminal connected to the first network, a second network, a second terminal connected to the second network, and a gateway apparatus connected to the first and second networks, wherein the gateway apparatus comprises a conversion unit that performs conversion of an image signal for enhancing resolution and image quality thereof, wherein

the gateway apparatus receives an image signal which includes a moving image or a still image and which is transmitted from the first terminal to the first network, and converts the received image signal for enhancing resolution and image quality using the conversion unit and transmits the converted image signal to the second terminal connected to the second network, wherein

the gateway apparatus further receives an image signal which includes a moving image or a still image and which is transmitted from the second terminal to the second network, and outputs the received image signal to the first network, and wherein the first terminal comprises means that receives the image signal output from the gateway apparatus to the first network, decodes the received image signal, and conyerts the decoded image signal using the conversion unit, for enhancing resolution and image quality thereof.

(Supplementary note 2) The communication system according to Supplementary note 1, wherein the gateway apparatus further comprises:

a reception unit that receives an image signal which includes a moving image or a still image and which is transmitted from the first terminal to the first network, the image signal;

a transmission unit that transmits the image signal, converted by the conversion unit, to the second terminal connected to the second network;

a second reception unit that receives an image signal which includes a moving image or a still image from the second terminal via the second network, the image signal; and

a second transmission unit that transmits the received image signal to the first terminal connected to the first network.

(Supplementary note 3) The communication system according to Supplementary note 2, wherein the conversion unit of the gateway apparatus comprises:

a decoding unit that decodes the image signal, received by the reception unit, in a scheme corresponding to capability information on the first terminal;

a resolution conversion unit that converts the resolution of the decoded image signal based on capability information on the second terminal for improving image quality thereof; and

an encoding unit that receives the image signal, converted by the resolution conversion unit, and encodes the received image signal in a scheme corresponding to the capability information on the second terminal.

(Supplementary note 4) The communication system according to one of Supplementary notes 1 to 3, wherein the first terminal comprises:

a decoding unit that decodes the received image signal;

a resolution conversion unit that converts the resolution of the decoded image signal for improving image quality thereof; and

a display unit that displays the converted image signal.

(Supplementary note 5) The communication system according to Supplementary note 3 or 4, wherein the resolution conversion unit performs motion vector re-search processing for a past reference image based on a motion vector decoded by the decoding unit and, using an image generated by applying a motion vector, determined by the re-search, to the reference image, converts the resolution of the image signal.
(Supplementary note 6) The communication system according to one of Supplementary notes 1 to 5, wherein the first network is a mobile circuit-switched network or a mobile packet network and the second network is a packet network or a next generation network (NGN).
(Supplementary note 7) The communication system according to one of Supplementary notes 1 to 5, wherein the first network is a mobile circuit-switched network or a mobile packet network and the second network is a 3.9th generation or 4th generation mobile packet network.
(Supplementary note 8) A communication method comprises:

a gateway receiving an image signal that includes a moving image or a still image, and that is transmitted from a first terminal via a first network, the image signal; and

the gateway converting the received image signal for enhancing resolution and image quality thereof and transmitting the converted image signal to a second terminal via a second network,

the gateway receiving an image signal that includes a moving image or a still image, and that is transmitted from the second terminal via the second network and outputting the received image signal to the first network; and

the first terminal receiving the image signal output from the gateway to the first network, decoding the received image signal, and converting the decoded image signal for enhancing resolution and image quality thereof.

(Supplementary note 9) The communication method according to Supplementary note 8, further comprising:

the gateway decoding the received image signal in a scheme corresponding to capability information on the first terminal;

the gateway converting the resolution of the decoded image signal based on capability information on the second terminal for improving image quality thereof; and

the gateway encoding the converted image signal in a scheme corresponding to the capability information on the second terminal.

(Supplementary note 10) The communication method according to Supplementary note 8 or 9, further comprising:

the first terminal decoding the received image signal;

the first terminal converting the resolution of the decoded image signal for improving image quality thereof; and

the first terminal displaying the converted image signal.

(Supplementary note 11) The communication method according to one of Supplementary notes 8 to 10, wherein the first network is a mobile circuit-switched network or a mobile packet network and the second network is a packet network or a next generation network (NGN).
(Supplementary note 12) The communication method according to one of Supplementary notes 8 to 10, wherein the first network is a mobile circuit-switched network or a mobile packet network and the second network is a 3.9th generation or 4th generation mobile packet network.
(Supplementary note 13) A gateway apparatus that is connected to a first terminal connected to a first network and that is connected to a second terminal connected to a second network, the gateway apparatus comprising:

a first reception unit that receives an image signal that includes a moving image or a still image, and that is transmitted from the first terminal via the first network;

a conversion unit that converts the received image signal for enhancing resolution and image quality thereof;

a first transmission unit that transmits the converted image signal to the second terminal connected to the second network;

a second reception unit that receives an image signal that includes a moving image or a still image, and that is transmitted from the second terminal via the second network; and

a second transmission unit that transmits the received image signal to the first terminal connected to the first network.

(Supplementary note 14) The gateway apparatus according to Supplementary note 13, wherein

the conversion unit comprises:

a decoding unit that decodes the image signal, received by the reception unit, in a scheme corresponding to capability information on the first terminal;

a resolution conversion unit that converts the resolution of the decoded image signal based on capability information on the second terminal for improving image quality thereof; and

an encoding unit that receives the image signal, converted by the resolution conversion unit, and encodes the received image signal in a scheme corresponding to the capability information on the second terminal.

(Supplementary note 15) The gateway apparatus according to Supplementary note 13 or 14, wherein the resolution conversion unit performs motion vector re-search processing for a past reference image based on a motion vector decoded by the decoding unit and, using an image generated by applying a motion vector, determined by the re-search, to the reference image, converts the resolution of the image signal.
(Supplementary note 16) A computer program that causes a computer, which configures a gateway apparatus that is connected to a first terminal connected to a first network and that is connected to a second terminal connected to a second network, to execute processing comprising:

receiving an image signal including a moving image or a still image and transmitted from the first terminal via the first network;

converting the received image signal for enhancing resolution and image quality thereof;

transmitting the converted image signal to the second terminal connected to the second network;

receiving an image signal including a moving image or a still image and transmitted from the second terminal via the second network; and

transmitting the received image signal to the first terminal connected to the first network.

(Supplementary note 17) The program according to Supplementary note 16, wherein in the conversion processing, the program causes the computer to execute the processing comprising:

decoding the received image signal in a scheme corresponding to capability information on the first terminal;

converting the resolution of the decoded image signal based on capability information on the second terminal for improving image quality thereof; and

receiving the converted image signal and encode the received image signal in a scheme corresponding to the capability information on the second terminal.

(Supplementary note 18) A terminal that transmits an image signal to a gateway apparatus via a first network and that receives an image signal transmitted to the gateway apparatus via a second network, the image signal including a moving image or a still image, the terminal comprising:

a reception unit that receives an image signal including a moving image or a still image, via the gateway apparatus, from a second terminal connected to the second network;

a decoding unit that decodes the received image signal;

a conversion unit that converts the resolution of the decoded image signal for improving image quality thereof; and

a display unit that displays the converted signal.

(Supplementary note 19) A computer program in this exemplary embodiment includes a program that causes a computer, which configures a terminal that transmits an image signal including a moving image or a still image to a gateway apparatus via a first network and that receives an image signal transmitted to the gateway apparatus via a second network, to execute:

reception processing that receives an image signal that includes a moving image or a still image from a second terminal, connected to the second network, via the gateway apparatus;

decoding processing that decodes the received image signal;

conversion processing that converts the resolution of the decoded image signal for improving image quality thereof; and

display processing that displays the converted signal.

The disclosure of Patent Documents given above is hereby incorporated by reference into this specification. The exemplary embodiments and the examples may be changed and adjusted in the scope of the entire disclosure (including claims) of the present invention and based on the basic technological concept. In the scope of the claims of the present invention, various disclosed elements may be combined and selected in a variety of ways. That is, it is apparent that the present invention includes various modifications and changes that may be made by those skilled in the art according to the entire disclosure, including claims, and technological concepts thereof.

What is claimed is:

1. A communication system comprising:
a first network;
a first terminal connected to said first network;
a second network;
a second terminal connected to said second network; and
a gateway apparatus connected to said first and second networks, said gateway apparatus comprising
a conversion unit that performs conversion of an image signal for enhancing resolution and image quality thereof, wherein
said gateway apparatus receives an image signal that includes a moving image or a still image, and that is transmitted from said first terminal t6 said first network, performs conversion of said received image signal for enhancing resolution and image quality thereof, using said conversion unit, and transmits a image signal resulting from said conversion to said second terminal connected to said second network, wherein
said gateway apparatus further receives an image signal that includes a moving image or a still image, and that is transmitted from said second terminal to said second network, and outputs said received image signal to said first network, and wherein
said first terminal comprises
a conversion unit that performs conversion of an image signal for enhancing resolution and image quality thereof, wherein said first terminal receives said image signal output from said gateway apparatus to said first network, decodes said received image signal, and performs conversion of said decoded image signal for enhancing resolution and image quality thereof, using said conversion unit of said first terminal.

2. The communication system according to claim 1, wherein said gateway apparatus further comprises:
a first reception unit that receives an image signal that includes a moving image or a still image, and that is transmitted from said first terminal to said first network;
a first transmission unit that transmits an image signal, resulting from conversion by said conversion unit, to said second terminal connected to said second network;
a second reception unit that receives an image signal that includes a moving image or a still image from said second terminal via said second network; and
a second transmission unit that transmits said received image signal to said first terminal connected to said first network.

3. The communication system according to claim 2, wherein in said gateway apparatus, said conversion unit comprises:
a decoding unit that decodes an image signal received by said first reception unit, in a scheme corresponding to capability information on said first terminal;
a resolution conversion unit that converts resolution of said decoded image signal, based on capability information on said second terminal to improve image quality thereof; and
an encoding unit that receives an image signal converted by said resolution conversion unit, and encodes said received image signal in a scheme corresponding to capability information on said second terminal.

4. The communication system according to claims 1, wherein said first terminal comprises:
a reception unit that receives an image signal output from said gateway apparatus to said first network;
a decoding unit that decodes said received image signal;
a resolution conversion unit that converts resolution of said decoded image signal to improve image quality thereof, said resolution conversion unit composing said conversion unit of said first terminal; and
a display unit that displays said converted image signal.

5. The communication system according to claim 3, wherein said resolution conversion unit performs motion vector re-search for a past reference image, based on a motion vector decoded by said decoding unit, and,
using an image obtained by applying a motion vector, found by said re-search, to said reference image, performs conversion of resolution of said image signal.

6. The communication system according to claim 1, wherein said first network includes a mobile circuit-switched network or a mobile packet network, and
said second network includes a packet network or a next generation network (NGN).

7. The communication system according to claim 1, wherein said first network includes a mobile circuit-switched network or a mobile packet network and
said second network includes a 3.9th generation or 4th generation mobile packet network.

8. A communication method comprising:
a gateway receiving an image signal that includes a moving image or a still image, and that is transmitted from a first terminal via a first network;
said gateway performing conversion of said received image signal for enhancing resolution and image quality thereof and transmitting an image signal resulting from said conversion to a second terminal via a second network,
said gateway receiving an image signal that includes a moving image or a still image, and that is transmitted from said second terminal via said second network and outputting said received image signal to said first network; and
said first terminal receiving an image signal output from said gateway to said first network, decoding said received image signal, and converting said decoded image signal for enhancing resolution and image quality thereof.

9. The communication method according to claim 8, further comprising:
said gateway decoding said received image signal in a scheme corresponding to capability information on said first terminal;
said gateway converting resolution of said decoded image signal for improving image quality thereof, based on capability information on said second terminal; and
said gateway encoding said converted image signal in a scheme corresponding to capability information on said second terminal.

10. The communication method as defined claim 8, further comprising:
said first terminal decoding said received image signal;
said first terminal converting resolution of said decoded image signal for improving image quality thereof; and
said first terminal displaying said converted image signal.

11. The communication method according to claim 8, wherein said first network includes a mobile circuit-switched network or a mobile packet network, and
said second network includes a packet network or a next generation network (NGN).

12. The communication method according to claim 8, wherein said first network includes a mobile circuit-switched network or a mobile packet network, and
said second network includes a 3.9th generation or 4th generation mobile packet network.

13. A gateway apparatus that is connected to a first terminal connected to a first network and that is connected to a second terminal connected to a second network, said gateway apparatus comprising:
a first reception unit that receives an image signal that includes a moving image or a still image, and that is transmitted from said first terminal via said first network;
a conversion unit that performs conversion of said received image signal for enhancing resolution and image quality thereof;
a first transmission unit that transmits an image signal resulting from said conversion to said second terminal connected to said second network;
a second reception unit that receives an image signal that includes a moving image or a still image, and that is transmitted from said second terminal via said second network; and
a second transmission unit that transmits said received image signal to said first terminal connected to said first network.

14. The gateway apparatus according to claim 13, wherein said conversion unit comprises:
a decoding unit that decodes an image signal, received by said reception unit, in a scheme corresponding to capability information on said first terminal;
a resolution conversion unit that converts resolution of said decoded image signal, based on capability information on said second terminal to improve image quality thereof; and
an encoding unit that receives an image signal converted by said resolution conversion unit, and encodes said received image signal in a scheme corresponding to capability information on said second terminal.

15. The gateway apparatus according to claim 13, wherein said resolution conversion unit performs motion vector re-search for a past reference image, based on a motion vector decoded by said decoding unit and, using an image obtained by applying a motion vector, found by the re-search, to said reference image, converts resolution of said image signal.

16-19. (canceled)
